(19) United States
(12) Patent Application Publication
(10) Pub. No.: US 2016/0375399 A1
(43) Pub. Date: Dec. 29, 2016

(54) CARBON DIOXIDE ABSORBENT AND METHOD FOR REGENERATING CARBON DIOXIDE ABSORBENT

(71) Applicant: GWANGJU INSTITUTE OF SCIENCE AND TECHNOLOGY, Gwangju (KR)

(72) Inventors: Ji-Woong Park, Gwangju (KR); Ramachandran Rajamanickam, Gwangju (KR); Hyungsoo Kim, Gwangju (KR)

(21) Appl. No.: 15/191,537

(22) Filed: Jun. 24, 2016

(30) Foreign Application Priority Data
Jun. 24, 2015 (KR) 10-2015-0089500

(51) Int. Cl. B01D 53/14; B01D 53/62; B01D 53/78

(52) U.S. Cl. CPC B01D 53/1425; B01D 53/1475; B01D 53/1493; B01D 53/78; B01D 53/62; B01D 2252/2041; B01D 2252/20421; B01D 2252/20431; B01D 2258/0283

(57) ABSTRACT

A carbon dioxide absorbent according to the present disclosure includes a diamine compound including primary and tertiary amines, a polar aprotic solvent and a protic solvent.

In addition, a method for regenerating a carbon dioxide absorbent according to the present disclosure includes a carbon dioxide absorbent including a diamine compound including primary and tertiary amines, a polar aprotic solvent and a protic solvent absorbing carbon dioxide, and removing the carbon dioxide by heating the carbon dioxide-absorbed carbon dioxide absorbent.

### FIELD OF THE INVENTION

The present disclosure relates to a carbon dioxide absorbent and a method for regenerating a carbon dioxide absorbent.

More specifically, the present disclosure relates to a method for regenerating a carbon dioxide absorbent reducing viscosity and heat capacity of the carbon dioxide absorbent and enhancing energy efficiency through lowering a regeneration temperature of the carbon dioxide absorbent by the carbon dioxide absorbent according to the present disclosure including a diamine compound, a polar aprotic solvent and a protic solvent,.

### BACKGROUND OF THE INVENTION

An increase in the greenhouse gas emission has caused global warming and climate changes occurring therefrom.

Particularly, a major contributor to global warming is carbon dioxide occupying 70% or more of the emitted greenhouse gas.

Such carbon dioxide is mostly emitted in power plants using fossil fuels, and the like, and therefore, carbon dioxide capturing carried out with a carbon dioxide absorbent is important. Meanwhile, when capturing carbon dioxide after combustion as in power plants, nitrogen included low carbon dioxide concentration needs to be handled, which causes difficulties in capturing the carbon dioxide.

Carbon dioxide absorbents based on aqueous amine solutions such as an aqueous monoethanolamine solution may corrode carbon dioxide capturing equipment when increasing monoethanolamine content. In addition, high energy is required to regenerate the carbon dioxide absorbent, and since carbon dioxide absorbent loss occurs, there is a problem in terms of process costs and efficiency.

Accordingly, carbon dioxide absorbents having new compositions capable of solving such problems have been required.

### SUMMARY OF THE INVENTION

The present disclosure is directed to providing a novel carbon dioxide absorbent having excellent carbon dioxide absorption and regeneration abilities, and capable of regenerating the carbon dioxide absorbent at low temperatures.

The present disclosure is also directed to providing a novel method for regenerating a carbon dioxide absorbent capable of regenerating a carbon dioxide absorbent at low temperatures.

In view of the above, a carbon dioxide absorbent of the present disclosure may include a diamine compound including primary and tertiary amines, a polar aprotic solvent and a protic solvent.

More specifically, the carbon dioxide absorbent according to one embodiment of the present disclosure may include the diamine compound in 30% by weight to 50% by weight with respect to 100% by weight of the total carbon dioxide absorbent. In addition, the carbon dioxide absorbent of the present disclosure may include the polar aprotic solvent and the protic solvent in 50% by weight to 70% by weight with respect to 100% by weight of the total carbon dioxide absorbent.

A method for regenerating a carbon dioxide absorbent according to another embodiment of the present disclosure may include a carbon dioxide absorbent including a diamine compound including primary and tertiary amines, a polar aprotic solvent and a protic solvent absorbing carbon dioxide, and removing the carbon dioxide by heating the carbon dioxide-absorbed carbon dioxide absorbent.

### BRIEF DESCRIPTION OF THE DRAWINGS

The objects and qualities of the present disclosure will become apparent from the following description of embodiments given in conjunction with the accompanying drawings, in which:

FIG. 1 is a graph showing amounts of carbon dioxide absorption and regeneration by a polar aprotic solvent;

FIG. 2 is a graph showing amounts of carbon dioxide absorption and regeneration by a protic solvent;

FIG. 3 is a graph showing amounts of carbon dioxide absorption and regeneration according to examples and a comparative example;

FIG. 4 is a graph showing amounts of carbon dioxide absorption and regeneration according to an example;

FIG. 5 is a graph showing viscosity of a carbon dioxide absorbent according to examples; and

FIG. 6 is a graph showing heat capacity of a carbon dioxide absorbent according examples.

### DETAILED DESCRIPTION OF THE EMBODIMENTS

Hereinafter, the present disclosure will be described in more detail with reference to embodiments, however, these embodiments are for illustrative purposes only, and the scope of the present disclosure is not limited to these embodiments.

A carbon dioxide absorbent is used in a carbon dioxide capturing process. The carbon dioxide absorbent is regenerated after absorbing carbon dioxide, and therefore, a carbon dioxide absorbent capable of reducing energy consumption caused by high specific heat and latent heat of the carbon dioxide absorbent is required.

In other words, a carbon dioxide absorbent capable of regenerating carbon dioxide at low temperatures, and a method for regenerating carbon dioxide using the same are required.

In addition, a carbon dioxide absorbent capable of reducing carbon dioxide absorbent loss, and capable of increasing working capacity is required.

As a result of extensive studies to develop a carbon dioxide absorbent capable of increasing working capacity while lowering a regeneration temperature of carbon dioxide, the inventors of the present disclosure have found out that the above-mentioned goals are capable of being achieved when using a diamine compound, a polar aprotic solvent and a protic solvent, and have completed the present disclosure.

A carbon dioxide absorbent according to the present disclosure may include a diamine compound, a polar aprotic solvent and a protic solvent.

The carbon dioxide absorbent may be used for capturing carbon dioxide in carbon dioxide mass emission sources such as power plants. Alternatively, the carbon dioxide absorbent may be used for removing carbon dioxide in order to enhance reaction product yields.

In other words, the carbon dioxide absorbent according to embodiments may be used in both cases when a partial pressure of carbon dioxide is high or low, and accordingly, may be used in various processes.

The diamine compound is for removing carbon dioxide.

The diamine compound may be a compound simultaneously including primary and tertiary amines for effectively removing carbon dioxide. In other words, the diamine compound may be a complex diamine compound.

For example, the diamine compound may be a compound including 3 carbon atoms to 30 carbon atoms. For example, the diamine compound may be a compound including 3 carbon atoms to 20 carbon atoms. For example, the diamine compound may be a compound including 3 carbon atoms to 10 carbon atoms.

For example, the primary amine of the diamine compound may be monoalkylamine, and the tertiary amine of the diamine compound may be trialkylamine.

For example, the diamine compound may be one or more types selected from the group consisting of N,N-diethylpropane-1,3-diamine, N,N-dibutylpropane-1,3-diamine and N,N-dibutylethane-1,2-diamine.

For example, the diamine compound may include a cyclo compound. Specifically, the diamine compound may include a cycloamine compound or a cycloalkyl compound. For example, the diamine compound may include a linear alkyl compound. For example, the diamine compound may include a branched alkyl group.

The primary amine in the diamine compound may react with carbon dioxide. For example, the primary amine in the diamine compound may react with carbon dioxide to form a carbon dioxide anion. For example, the primary amine in the diamine compound may react with carbon dioxide to form a carbonate salt.

The tertiary amine in the diamine compound may react with proton of an ammonium salt formed by the reaction between the primary amine and carbon dioxide. For example, the tertiary amine in the diamine compound may react with proton to form an ammonium salt.

For example, the content of the diamine compound may be from 30% by weight to 50% by weight with respect to 100% by weight of the total carbon dioxide absorbent.

When the diamine compound is used in less than 30% by weight, carbon dioxide absorption efficiency may decrease. In addition, when the diamine compound is used in greater than 50% by weight, absorption efficiency of the carbon dioxide absorbent may decrease, and viscosity of the carbon dioxide absorbent may increase.

Next, the polar aprotic solvent is for destabilizing the diamine compound reacting with carbon dioxide.

Specifically, the diamine compound reacting with carbon dioxide may include carbon dioxide anions and ammonium cations. In other words, the diamine compound reacting with carbon dioxide may form a salt. For example, carbon dioxide reacting with the diamine compound may include a carbonate salt.

The salt formed from the reaction of the diamine compound and carbon dioxide may be destabilized by the polar aprotic solvent. That is, the polar aprotic solvent is not able to stabilize the salt formed from the reaction of the diamine compound and carbon dioxide by hydrogen bonds, and accordingly, energy required to regenerate the carbon dioxide absorbent from the salt may be reduced.

In addition, the polar aprotic solvent is an organic solvent having low specific heat, and from the salt formed from the reaction of the diamine compound and carbon dioxide, energy required to regenerate the carbon dioxide absorbent may be reduced.

For example, the content of the polar aprotic solvent may be from 40% by weight to 70% by weight with respect to 100% by weight of the total carbon dioxide absorbent.

When the polar aprotic solvent is used in less than 40% by weight, heat capacity of the carbon dioxide absorbent may increase. In addition, when the polar aprotic solvent is used in greater than 70% by weight, the carbon dioxide absorption amount may decrease.

The polar aprotic solvent may include one or more types selected from the group consisting of dimethylformamide (DMF), dimethylacetamide (DMAc), N-methylpyrrolidone (NMP), hexamethylphosphoric acid triamide (HMPA), dimethyl sulfoxide, tetrahydrofuran and chloroform.

Next, the protic solvent may increase a carbon dioxide absorption rate.

The protic solvent may include one or more types selected from the group consisting of water and alcohols.

For example, the content of the protic solvent may be from 0.00000001% by weight to 20% by weight with respect to 100% by weight of the total carbon dioxide absorbent. For example, the content of the protic solvent may be from 5% by weight to 20% by weight with respect to 100% by weight of the total carbon dioxide absorbent.

When the protic solvent content is greater than 20% by weight, stability of the salt formed from the reaction of the diamine compound and carbon dioxide may increase. Accordingly, a high temperature condition may be required to regenerate the carbon dioxide absorbent from the salt formed from the reaction of the diamine compound and carbon dioxide. For example, a temperature of 100° C. or higher may be required to regenerate the carbon dioxide from the salt formed from the reaction of the diamine compound and carbon dioxide.

In addition, the salt formed from the reaction of the diamine compound and carbon dioxide may be stabilized by hydrogen bonds with the protic solvent, and accordingly, high energy may be required to regenerate the carbon dioxide absorbent. In addition, high regeneration energy may be required since specific heat of the solvent is high. Furthermore, there is a problem in that the amount of carbon dioxide absorbent loss is high.

When the content of the protic solvent is less than 0.00000001% by weight, the carbon dioxide absorption rate and/or the carbon dioxide absorption amount may decrease.

By mixing the polar aprotic solvent and the protic solvent in a specific ratio, energy required to regenerate the carbon dioxide absorbent may be reduced, and working capacity may increase.

Herein, the ratio of the polar aprotic solvent may be higher than the ratio of the protic solvent. For example, the polar aprotic solvent may be included in a higher weight than the protic solvent.

The ratio of the polar aprotic solvent and the protic solvent may be determined considering physical properties such as viscosity and heat capacity required in a process.

The content of the polar aprotic solvent and the protic solvent may be from 50% by weight to 70% by weight with respect to 100% of the total carbon dioxide absorbent.

By including the polar aprotic solvent and the protic solvent in 50% by weight to 70% by weight, the carbon dioxide regeneration temperature may be lowered to 100° C. or lower. In addition, loss of the carbon dioxide absorbent may be reduced, and working capacity may increase.

The carbon dioxide absorbent of the present disclosure formed in the composition described above is capable of effectively regenerating the carbon dioxide absorbent at a low temperature of 100° C. or lower while effectively absorbing carbon dioxide. In addition, process efficiency and process costs may be enhanced since carbon dioxide absorbent loss is small.

Meanwhile, a method for regenerating a carbon dioxide absorbent may include a carbon dioxide absorbent absorbing carbon dioxide, and removing the carbon dioxide by heating the carbon dioxide-absorbed carbon dioxide absorbent.

Herein, the carbon dioxide absorbent may include a diamine compound including primary and tertiary amines, a polar aprotic solvent and a protic solvent.

For example, the content of the diamine compound may be from 30% by weight to 50% by weight with respect to 100% by weight of the total carbon dioxide absorbent.

For example, the content of the polar aprotic solvent and the protic solvent may be from 50% by weight to 70% by weight with respect to 100% by weight of the total carbon dioxide absorbent.

For example, the content of the protic solvent may be from 0.00000001% by weight to 20% by weight with respect to 100% by weight of the total carbon dioxide absorbent.

For example, the content of the polar aprotic solvent may be from 40% by weight to 70% by weight with respect to 100% by weight of the total carbon dioxide absorbent.

The absorbing of a carbon dioxide absorbent may include forming a carbonate salt from the reaction of the diamine compound and carbon dioxide.

The absorbing of a carbon dioxide absorbent may be carried out at a temperature of 40° C. or lower. For example, the absorbing of a carbon dioxide absorbent may be carried out at 30° C. to 40° C. The carbon dioxide absorbent may effectively absorb carbon dioxide at a temperature of 30° C. to 40° C.

The removing of the carbon dioxide may include regenerating the carbon dioxide absorbent by removing carbon dioxide from the carbonate salt.

The removing of the carbon dioxide may be carried out at a temperature of 100° C. or lower. For example, the removing of the carbon dioxide may be carried out at a temperature of 70° C. to 100° C. For example, the removing of the carbon dioxide may be carried out at a temperature of 70° C. to 90° C.

When the removing of the carbon dioxide is carried out at a temperature of 100° C. or higher, high heat energy is required to regenerate the carbon dioxide absorbent, and accordingly, process costs and process efficiency may be reduced.

In embodiments, process costs may be reduced by lowering the temperature required for regenerating the carbon dioxide absorbent to 100° C. or lower.

Hereinafter, the present disclosure will be described in more detail with reference to specific examples.

Examples of the present disclosure may be modified to various forms, and the scope of the present disclosure should not be construed as being limited to the examples described below.

The inventors of the present disclosure measured effects depending on the compositions through various tests for the carbon dioxide absorbent according to the present disclosure to effectively absorb carbon dioxide, and to regenerate carbon dioxide at low temperatures.

### TEST EXAMPLE 1

Carbon dioxide absorption and carbon dioxide regeneration amounts and time by the diamine compound depending on the changes in the concentration of the polar aprotic solvent were measured.

A molar ratio of the diamine compound and the protic solvent was fixed, and changes in the absorbed and regenerated amounts of carbon dioxide with an increase in the molar ratio of the polar aprotic solvent were measured.

Herein, N,N-diethylpropane-1,3-diamine was used as the diamine compound.

Herein, N-methylpyrrolidone (NMP) was used as the polar aprotic solvent.

Herein, water was used as the protic solvent. Herein, the ratio of the diamine compound, the NMP and the water was a molar ratio.

Herein, in the absorption, 50 ml of carbon dioxide was supplied per minute.

The carbon dioxide absorption was carried out at a temperature of 30° C., and the carbon dioxide regeneration was each measured at 70° C., 80° C. and 90° C.

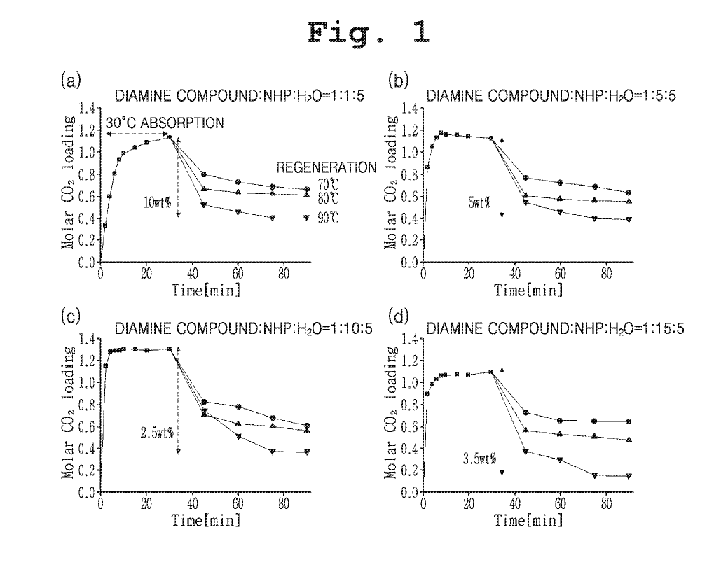

FIG. 1 is a graph showing absorbed and regenerated concentrations of carbon dioxide depending on the time measured in Test Example 1.

Referring to FIG. 1, it was seen that regeneration of the carbon dioxide absorbent achieved by carbon dioxide removal was effectively progressed as the molar ratio of NMP, the polar aprotic solvent, increased at 90° C. In other words, it was seen that more carbon dioxide regeneration occurred as the molar ratio of NMP increased.

It was seen that, as the molar ratio of the polar aprotic solvent increased, the rate of carbon dioxide absorbent regeneration increased.

Meanwhile, as the molar ratio of NMP, the polar aprotic solvent, increased, the concentration of the diamine compound relatively decreased, and accordingly, it was seen that working capacity (mg CO₂/gₛₒₗᵤₜᵢₒₙ) depending on the carbon dioxide absorption and regeneration decreased.

In other words, the diamine compound is capable of absorbing carbon dioxide by reacting with the carbon dioxide, and therefore, it can be seen that working capacity depending on the carbon dioxide absorption and regeneration decreases as the concentration of the diamine compound decreases. This is due to the fact that one molecule of the diamine compound reacts with one molecule of carbon dioxide. Accordingly, carbon dioxide absorbents with various compositions may be used depending on the partial pressure condition of carbon dioxide. For example, when carbon dioxide has a high partial pressure, or when carbon dioxide has a low partial pressure, the carbon dioxide absorbent may be utilized in various processes by changing the composition of the carbon dioxide absorbent.

### TEST EXAMPLE 2

Carbon dioxide absorption and carbon dioxide regeneration amounts and time by the diamine compound depending on the changes in the concentration of the protic solvent were measured.

The test was performed in the same manner as in Test Example 1 except that a molar ratio of the diamine compound and the polar aprotic solvent was fixed, and changes in the absorbed and regenerated amounts of carbon dioxide with an increase in the molar ratio of the protic solvent were measured.

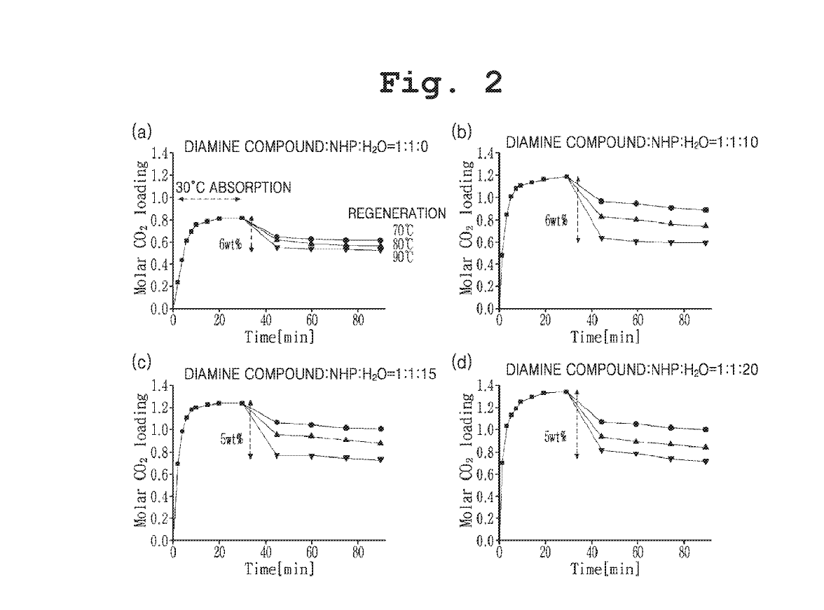

FIG. 2 is a graph showing absorbed and regenerated concentrations of carbon dioxide depending on the time measured in Test Example 2.

Referring to FIG. 2, it was seen that the carbon dioxide absorption rate increased as the content of water, the protic solvent, increased in conditions of carbon dioxide absorption at 30° C. and carbon dioxide absorbent regeneration at 90° C.

In addition, it was seen that saturated absorption capacity of carbon dioxide (mol CO₂) increased as the water content increased. Furthermore, it was seen that, the amount of the carbonate salt remaining at 90° C. increased as the water content increased.

Through Test Examples 1 and 2, it can be seen that the absorbed and regenerated amounts of carbon dioxide are determined by the ratio of the protic solvent and the polar aprotic solvent.

### TEST EXAMPLE 3

In Examples 1 and 2 and Comparative Example 1, carbon dioxide absorption and carbon dioxide regeneration amounts and time by the diamine compound were repetitively measured.

In the carbon dioxide absorbent of Example 1, 30% by weight of the diamine compound and 70% by weight of N-methylpyrrolidone (NMP) were mixed.

In the carbon dioxide absorbent of Example 2, 50% by weight of the diamine compound and 50% by weight of N-methylpyrrolidone (NMP) were mixed.

In Comparative Example 1, 30% by weight of the diamine compound and 70% by weight of water were mixed.

Herein, as the diamine compounds in Example 1 and 2 and Comparative Example 1, N,N-diethylpropane-1,3-diamine was used.

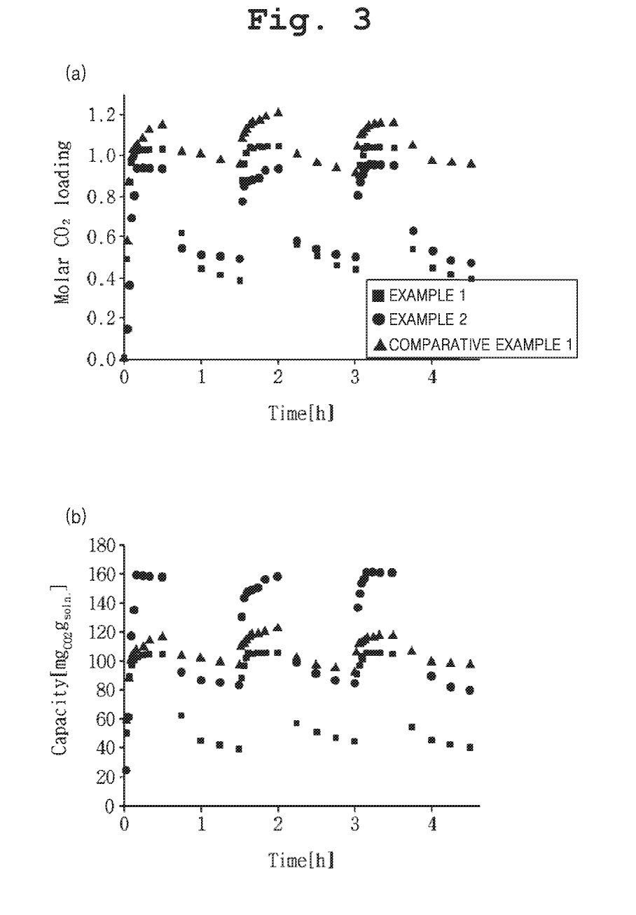

FIG. 3 is a graph showing the results of repetitively measuring absorbed and regenerated concentrations of carbon dioxide depending on the time measured in Examples 1 and 2 and Comparative Example 1.

The carbon dioxide absorption was carried out at a temperature of 25° C., and the carbon dioxide regeneration was carried out at 90° C.

Herein, in the absorption, 50 ml of carbon dioxide was supplied per minute.

Referring to FIG. 3, it was seen that the carbon dioxide absorbents according to Example 1 and Example 2 effectively went through carbon dioxide absorption and regeneration.

Meanwhile, Comparative Example 1 had a high carbon dioxide absorption amount (mg CO₂/gₛₒₗᵤₜᵢₒₙ) in the initial reaction time with carbon dioxide, however, carbon dioxide degeneration was difficult to occur.

In other words, through Test Example 3, it was seen that carbon dioxide regeneration effectively occurred at a temperature condition of 100° C. or lower by dissolving the diamine-based compound in a polar aprotic solvent, or dissolving a diamine-based compound in a solvent mixing a polar aprotic solvent and a protic solvent.

Specifically, when a carbon dioxide absorbent includes the polar aprotic solvent, an energy level of the produced carbonate salt increases due to carbon dioxide absorption, and accordingly, activation energy in the step of losing carbon dioxide decreases, and as a result, the carbon dioxide absorbent may be effectively regenerated under a temperature condition of 100° C. or lower.

In addition, in the same temperature condition of 90° C., the carbon dioxide absorbents according to Examples 1 and 2 were readily regenerated, and accordingly, it was seen that the amount of carbon dioxide absorbent loss was small.

Meanwhile, the carbon dioxide absorbent according to Comparative Example 1 was difficult to be regenerated due to high specific heat of water. In other words, it was seen that Comparative Example 1 had a higher carbon dioxide absorption amount compared to Examples 1 and 2, but had a lower carbon dioxide absorbent regeneration amount, and accordingly, carbon dioxide absorbent loss was high. As a result, process efficiency may decrease, and process costs may increase.

### TEST EXAMPLE 4

In order to optimize carbon dioxide absorption and regeneration conditions, efficiency of the carbon dioxide absorbent depending on the composition ratio of the diamine compound, NMP and water was measured.

Herein, N,N-diethylpropane-1,3-diamine was used as the diamine compound.

Table 1 shows results of measuring working capacity, viscosity and heat capacity depending on the composition of the carbon dioxide absorbent.

TABLE 1

| | | | | Heat Capacity | |
|---|---|---|---|---|---|
| Composition | Working | | | (J/g · K) | |
| (wt %) | Capacity | Viscosity (cP) | | Prior to | After |
| (PTDA/ | (Working | | At | Absorbing | Absorbing |
| NMP/H2O) | Efficiency) | At 30° C. | 40° C. | CO₂ | CO₂ |
| 30% MEA | — | — | — | 3.59 | 3.14 |
| (aq.) | | | | | |
| 30/60/10 | 4% (0.48) | 24.5 | 13.6 | 2.59 | 2.66 |
| 30/65/5 | 5% (0.56) | 17.6 | 8.1 | 2.38 | 2.39 |
| 30/70/0 | 6% (0.64) | 7.3 | 5.1 | — | — |
| 35/45/20 | 7% (0.65) | 94.1 | 35.3 | 3.04 | 2.78 |
| 35/50/15 | 6% (0.67) | 60.7 | 29.2 | 2.81 | 2.72 |
| 35/55/10 | 6% (0.56) | 37.7 | 16.7 | 2.65 | 2.53 |
| 35/60/5 | 5% (0.46) | 27.2 | 12.1 | 2.42 | 2.41 |
| 35/65/0 | — | 13.9 | 7.91 | — | — |
| 40/40/20 | 7% (0.56) | — | — | — | — |
| 40/45/15 | 5% (0.48) | 99.3 | 42.4 | 2.87 | 2.73 |
| 40/55/5 | 8% (0.64) | 35.3 | 17.3 | 2.47 | 2.43 |
| 40/60/0 | — | 19.4 | 13.1 | — | — |
| 45/50/5 | 7% (0.50) | — | — | 2.48 | 2.46 |
| 50/40/10 | 8% (0.48) | — | — | — | — |
| 50/45/5 | 7% (0.44) | — | — | 2.50 | 2.48 |

Meanwhile, in Example 3, the reaction was carried out under the same condition as in Test Example 1 except that 40% by weight of the diamine compound, 55% by weight of N-methylpyrrolidone (NMP) and 5% by weight of water were mixed as the carbon dioxide absorbent of Example 3, and the carbon dioxide absorption was carried out at a temperature of 30° C. to 40° C.

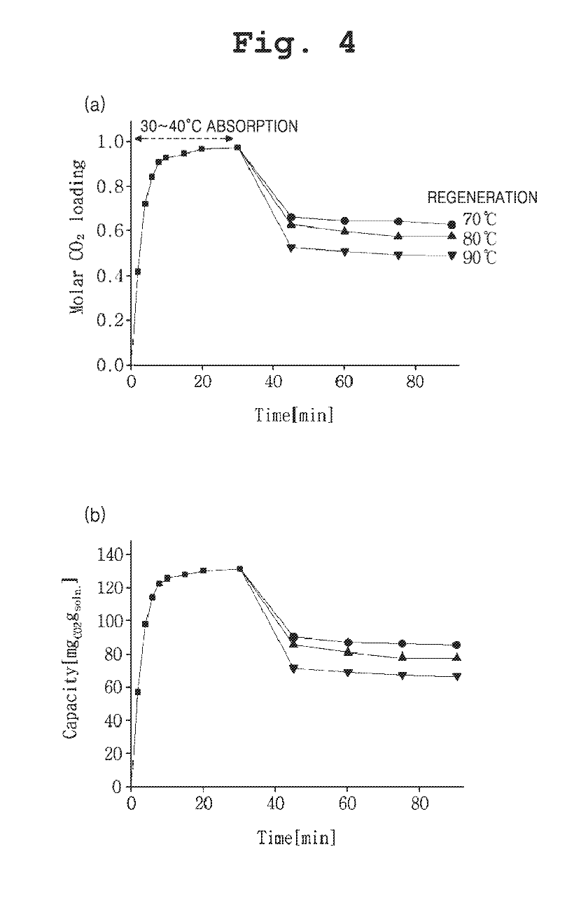

FIG. 4 is a graph showing absorbed and regenerated concentrations of carbon dioxide depending on the time measured in Example 3.

Referring to FIG. 4 and Table 1, it was seen that carbon dioxide working capacity was 8% by weight in Example 3. In addition, referring to Table 1, it was seen that carbon dioxide working capacity of the carbon dioxide absorbents according to the examples was from 4% to 8%.

Carbon dioxide absorption capacity (mol CO₂/mol primary-tertiary diamine) measured under the conditions of carbon dioxide absorption at 30° C. and carbon dioxide absorbent regeneration at 90° C. may have a value of 0.44 to 0.67.

The measured carbon dioxide absorption capacity may increase as the diamine compound composition increases. Meanwhile, the measured carbon dioxide absorption capacity may decrease as the polar aprotic solvent composition increases. In addition, the measured carbon dioxide absorption capacity may decrease as the protic solvent composition increases.

Depending on the carbon dioxide absorbent using environments such as power plants, carbon dioxide absorption capacity may be enhanced by adjusting the compositions of the diamine compound, the aprotic solvent and the protic solvent.

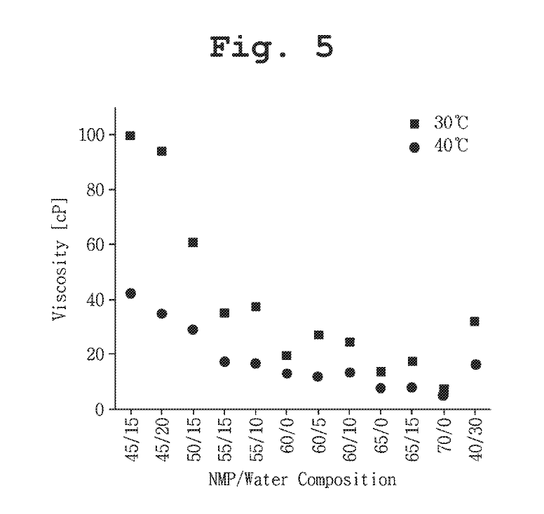

In addition, FIG. 5 is a graph showing viscosity depending on the composition ratio of the diamine compound, NMP and water. Referring to FIG. 5, the x-axis values represent % by weight of the polar aprotic solvent and water without including the diamine compound.

Herein, the viscosity of the carbon dioxide absorbent was measured after absorbing carbon dioxide.

The carbon dioxide absorbents according to the examples may have viscosity of 1 cP to 40 cP at 30° C. For example, the carbon dioxide absorbents according to the examples may have viscosity of 5 cP to 40 cP at 30° C. For example, the carbon dioxide absorbents according to the examples may have viscosity of 7.3 cP to 37.7 cP at 30° C.

The carbon dioxide absorbents according to the examples may have viscosity of 1 cP to 40 cP at 40° C. For example, the carbon dioxide absorbents according to the examples may have viscosity of 5 cP to 40 cP at 40° C. For example, the carbon dioxide absorbents according to the examples may have viscosity of 5.1 cP to 35.3 cP at 40° C.

The measured carbon dioxide absorbent viscosity may increase as the diamine compound composition increases. Meanwhile, the measured carbon dioxide absorbent viscosity may decrease as the polar aprotic solvent composition increases. In addition, the measured carbon dioxide absorbent viscosity may increase as the protic solvent composition increases.

Depending on the carbon dioxide absorbent using environments such as power plants, carbon dioxide absorbent viscosity may be reduced by adjusting the compositions of the diamine compound, the aprotic solvent and the protic solvent.

When the carbon dioxide absorbent viscosity measured after absorbing carbon dioxide is greater than 40 cP under the temperature condition of 30° C. or 40° C., pipeline flowability in the carbon dioxide capturing process decreases, and consequently, process efficiency may decrease.

In the carbon dioxide absorbents according to the examples, the viscosity of the carbon dioxide absorbents measured after absorbing carbon dioxide is 40 cP or less under the temperature condition of 30° C. or 40° C., and therefore, pipeline flowability may be enhanced in the process. Consequently, process efficiency may be enhanced.

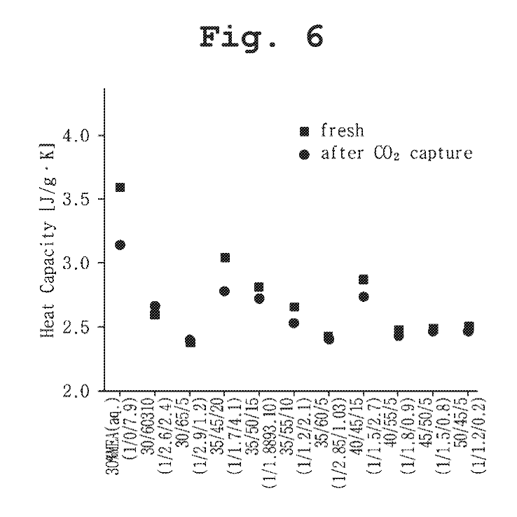

In addition, FIG. 6 is a graph showing heat capacity depending on the composition ratio of the diamine compound, NMP and water. Referring to FIG. 6, the x-axis values represent the molar ratio of the diamine compound/NMP/H₂O.

The carbon dioxide absorbents according to the examples may have heat capacity of 3.0 J/g·K or less when measured prior to absorbing carbon dioxide. For example, the carbon dioxide absorbents according to the examples may have heat capacity of 2.0 J/g·K to 3.0 J/g·K when measured prior to absorbing carbon dioxide. For example, the carbon dioxide absorbents according to the examples may have heat capacity of 2.42 J/g·K to 2.87 J/g·K when measured prior to absorbing carbon dioxide.

Meanwhile, Comparative Example 2 is an aqueous monoethanolamine (MEA) solution. Comparative Example 2 includes monoethanolamine in 30% by weight with respect to the total weight of the aqueous monoethanolamine solution.

The carbon dioxide absorbent according to Comparative Example 2 has heat capacity of 3.59 J/g·K when measured prior to absorbing carbon dioxide.

The carbon dioxide absorbents according to the examples may have heat capacity of 2.8 J/g·K or less when measured after absorbing carbon dioxide. For example, the carbon dioxide absorbents according to the examples may have heat capacity of 2.0 J/g·K to 2.8 J/g·K measured after absorbing carbon dioxide. For example, the carbon dioxide absorbents according to the examples may have heat capacity of 2.41 J/g·K to 2.73 J/g·K when measured after absorbing carbon dioxide.

Meanwhile, Comparative Example 2 has heat capacity of 3.14 J/g·K when measured after loading 0.59 mol of carbon dioxide and absorbing the carbon dioxide.

As in the results described above, it can be seen that the carbon dioxide absorbents according to the examples have low heat capacity and uses smaller amounts of energy than the aqueous alkanolamine solution in capturing and regenerating carbon dioxide.

The carbon dioxide absorbent according to the present disclosure may have excellent carbon dioxide absorption and regeneration abilities by mixing a diamine compound, a polar aprotic solvent and a protic solvent. In addition, carbon dioxide absorbent loss may be reduced, and working capacity may increase.

The carbon dioxide absorbent according to the present disclosure includes a polar aprotic solvent having low specific heat, and therefore, is capable of lowering a carbon dioxide regeneration temperature, and lowering viscosity of the carbon dioxide absorbent. Consequently, process costs and process efficiency may be enhanced.

In addition, the carbon dioxide absorbent according to the present disclosure absorbs carbon dioxide with various partial pressures and therefore, is capable of being used in various processes, and consequently, is capable of enhancing process efficiency.

While the present disclosure has been described focusing on the exemplary embodiments, these are for illustrative purposes only and do not limit the present disclosure, and it will be apparent to those skilled in the art that the present disclosure covers various modifications and variations within the scope that does not depart from intrinsic characteristics of the exemplary embodiments. For example, each constituent specifically included in the exemplary embodiments may be modified. In addition, differences relating to such modifications and variations shall be interpreted to be included in the scope of the present disclosure defined by the appended claims. Accordingly, the technological scope of the present disclosure shall be determined by the appended claims and not be limited to the descriptions made in the detailed descriptions of the specification.

What is claimed is:

1. A carbon dioxide absorbent comprising:
a diamine compound including primary and tertiary amines;
a polar aprotic solvent; and
a protic solvent.

2. The carbon dioxide absorbent of claim 1 comprising the diamine compound in 30% by weight to 50% by weight.

3. The carbon dioxide absorbent of claim 1 comprising the polar aprotic solvent and the protic solvent in 50% by weight to 70% by weight.

4. The carbon dioxide absorbent of claim 1 comprising the polar aprotic solvent in higher % by weight compared to the protic solvent.

5. The carbon dioxide absorbent of claim 1, wherein the protic solvent is included in 0.00000001% by weight to 20% by weight.

6. The carbon dioxide absorbent of claim 1, wherein the diamine compound includes 3 carbon atoms to 30 carbon atoms.

7. The carbon dioxide absorbent of claim 1, wherein the polar aprotic solvent includes one or more types selected from the group consisting of dimethylformamide (DMF), dimethylacetamide (DMAc), N-methylpyrrolidone (NMP), hexamethylphosphoric acid triamide (HMPA), dimethyl sulfoxide, tetrahydrofuran and chloroform.

8. The carbon dioxide absorbent of claim 1, wherein the protic solvent is one or more types selected from the group consisting of water and an alcohol.

9. The carbon dioxide absorbent of claim 1, which has viscosity of 1 cP to 40 cP at 30° C.

10. The carbon dioxide absorbent of claim 1, which has viscosity of 1 cP to 40 cP at 40° C.

11. The carbon dioxide absorbent of claim 1, wherein heat capacity of the carbon dioxide absorbent measured prior to absorbing carbon dioxide is 3.0 J/g·K or less.

12. The carbon dioxide absorbent of claim 1, wherein heat capacity of the carbon dioxide absorbent measured after absorbing carbon dioxide is 2.8 J/g·K or less.

13. A method for regenerating a carbon dioxide absorbent comprising:
a carbon dioxide absorbent including a diamine compound including primary and tertiary amines, a polar aprotic solvent and a protic solvent absorbing carbon dioxide; and
removing the carbon dioxide by heating the carbon dioxide-absorbed carbon dioxide absorbent.

14. The method for regenerating a carbon dioxide absorbent of claim 13, wherein the absorbing of a carbon dioxide absorbent includes forming a carbonate salt from a reaction of the diamine compound and carbon dioxide, and the absorbing of a carbon dioxide absorbent is carried out at 30° C. to 40° C.

15. The method for regenerating a carbon dioxide absorbent of claim 13, wherein the removing of the carbon dioxide includes regenerating the carbon dioxide absorbent by removing the carbon dioxide from the carbonate salt, and the removing of the carbon dioxide is carried out at a temperature of 100° C. or lower.
